(19) United States
(12) Patent Application Publication
(10) Pub. No.: US 2013/0321714 A1
(43) Pub. Date: Dec. 5, 2013

(54) ELECTRONIC APPARATUS, CONTROL METHOD OF AN ELECTRONIC APPARATUS, AND CONTROL PROGRAM OF AN ELECTRONIC APPARATUS

(71) Applicant: KABUSHIKI KAISHA TOSHIBA, Tokyo (JP)

(72) Inventors: Kaori KOBAYASHI, Kumagaya-shi (JP); Yasuhiko KITAMURA, Osato-gun (JP); Akira ARAFUNE, Fukaya-shi (JP); Mitsutaka KUWABARA, Fukaya-shi (JP); Tooru NAKAGAWA, Fukaya-shi (JP)

(73) Assignee: Kabushiki Kaisha Toshiba, Tokyo (JP)

(21) Appl. No.: 13/858,811

(22) Filed: Apr. 8, 2013

(30) Foreign Application Priority Data
May 31, 2012 (JP) 2012-125471

(51) Int. Cl. H04N 5/262

(52) U.S. Cl. CPC H04N 5/2628
USPC 348/738

(57) ABSTRACT

According to one embodiment, an electronic apparatus includes: a first detector configured to detect an orientation of the electronic apparatus; a video display unit configured to display video; a second detector configured to detect whether an audio signal of the video is corresponding to multichannel reproduction; and a sound controller configured to cause a first speaker that is located on a top-left of the displayed video to output a surround L sound, cause a second speaker located on a bottom-left of the displayed video to output an ordinary L sound, cause a third speaker located on a top-right of the displayed video to output a surround R sound, and cause a fourth speaker located on a bottom-right of the displayed video to output an ordinary R sound, in a case that the audio signal is corresponding to the multi-channel reproduction.

### CROSS REFERENCE TO RELATED APPLICATION(S)

The application is based upon and claims the benefit of priority from Japanese Patent Application No. 2012-125471 filed on May 31, 2012, the entire contents of which are incorporated herein by reference.

### BACKGROUND

1. Field

The present invention relates to an electronic apparatus, a control method of an electronic apparatus, and a control program of an electronic apparatus.

2. Description of the Related Art

In recent years, portable electronic apparatus such as tablet PCs and smartphones have come into wide use. These electronic apparatus may be carried by users, and they may be changed in orientation (rotated about the axis that is perpendicular to the screen) according to the use environment. Among these electronic apparatus are ones which, when they are changed in orientation, can change the orientation of a displayed image to, for example, a portrait orientation or a landscape orientation according to the change in orientation.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIGS. 1A and 1B show appearances of a tablet PC (electronic apparatus) according to an embodiment and illustrate its operations.

FIGS. 2A and 2B show appearances of the tablet PC according to the embodiment and illustrate its operations.

FIG. 3 is a block diagram showing the configuration of the tablet PC according to the embodiment.

FIG. 4 is a flowchart of a process which is executed by the tablet PC according to the embodiment.

### DETAILED DESCRIPTION

An embodiment will be hereinafter described with reference to the drawings.

According to one embodiment, an electronic apparatus includes: a first detector configured to detect an orientation of the electronic apparatus; a video display unit configured to display video so that the video is oriented based on the detected orientation; a second detector configured to detect whether an audio signal of the video is corresponding to multichannel reproduction; and a sound controller configured to cause a first speaker that is located on a top-left of the displayed video as viewed from a position in front of the video display unit to output a surround L sound, cause a second speaker located on a bottom-left of the displayed video to output an ordinary L sound, cause a third speaker located on a top-right of the displayed video to output a surround R sound, and cause a fourth speaker located on a bottom-right of the displayed video to output an ordinary R sound, in a case that the second detector detects that the audio signal is corresponding to the multi-channel reproduction.

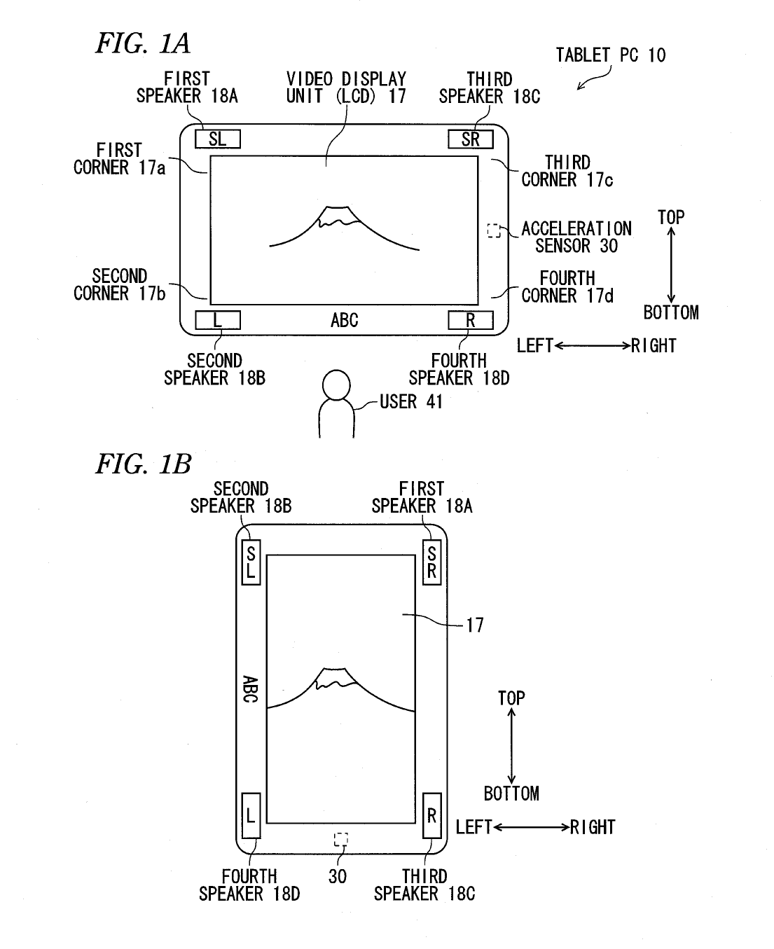

FIGS. 1A and 1B show appearances of a tablet PC 10 which is an electronic apparatus according to the embodiment, and illustrate its operations. The tablet PC 10 according to the embodiment is equipped with a detection unit such as an acceleration sensor 30 and detects an orientation of the tablet PC 10 using it. Although the embodiment is directed to a tablet PC, the concept of the embodiment can also be applied to other electronic apparatus such as a smartphone, a cell phone, and other kinds of PCs.

Video (in the examples of FIGS. 1A and 1B, a mountain image) is displayed on a video display unit 17 so as to be suitable for the shorter-axis direction (or longer-axis direction), for example, of the tablet PC 10 that is detected by the acceleration sensor 30.

As shown in FIG. 1A, the tablet PC 10 according to the embodiment is equipped with four speakers (first speaker 18A, second speaker 18B, third speaker 18C, and fourth speaker 18D) in the vicinities of the four respective corners (first corner 17a, second corner 17b, third corner 17c, and fourth corner 17d) of the video display unit 17.

In the tablet PC 10 according to the embodiment, a multichannel flag of the video (in the examples of FIGS. 1A and 1B, the mountain image) is detected. For example, multichannel flag detection processing is performed inside the tablet PC 10 being commanded by a CPU 101.

When a multichannel flag is detected from an audio signal corresponding to the video (in the examples of FIGS. 1A and 1B, the mountain image), as shown in FIGS. 1A and 1B, the speaker that is located on the top-left of the displayed video as viewed from the user outputs a surround L sound (SL sound), the speaker located on the bottom-left of the video outputs an ordinary L sound (L sound), the speaker located on the top-right of the video outputs a surround R sound (SR sound), and the speaker located on the bottom-right of the video outputs an ordinary R sound (R sound).

When no multichannel flag is detected, the two speakers that are located on the left of the displayed video (in the examples of FIGS. 1A and 1B, the mountain image) as viewed from the user output a stereo L sound and the two speakers located on the right of the video output a stereo R sound.

Next, a description will be made of the acceleration sensor which is a sensor for measuring acceleration. The acceleration sensor has various types such as a mechanical type, an optical type, and a semiconductor type. In any of these types, the basic principle of the acceleration sensor is that a position variation of a mass due to acceleration is detected.

Furthermore, the acceleration sensor is classified by the number of detection axes into a one-axis sensor, a two-axis sensor, and a three-axis sensor, for example. For example, a three-axis acceleration sensors used in a cell phone, for example, detects an inclination of the cell phone utilizing the gravitational acceleration of the earth and causes an image to be displayed in a correct direction.

In the embodiment, the acceleration sensor 30 detects an inclination of the tablet PC 10 utilizing the gravitational acceleration of the earth and causes video (in the examples of FIGS. 1A and 1B, the mountain image) to be displayed on the video display unit 17 in a correct direction.

Next, a description will be made of the multichannel flag. The term “multichannel” means one recording and reproduction/broadcast method. According to this scheme, one recording or broadcast event enables reproduction or reception on plural channels. In the case of sound, surround sound is categorized as this scheme.

The multichannel flag is a flag indicating that the multichannel is effective. The multichannel flag is transmitted as part of an audio signal of a movie content, a variety program, or the like. The fact that the multichannel is effective can be detected by detecting this flag.

The surround sound is one sound recording/reproduction method. The surround sound provides more channels (2.1 or more channels) than the monaural sound (1.0 channel) and the stereo sound (2.0 channels). At present, the number of channels of the surround sound is usually expressed as “5.1 ch,” “7.1 ch,” etc.

In case of ordinary speakers, one channel corresponds to 1 surround-sound channel. On the other hand, in the case of speakers dedicated to reproduction in an ultra-low frequency range (woofers), one channel corresponds to 0.1 surround-sound channel because they are much narrower in reproduction bandwidth than ordinary speakers.

FIG. 1A shows an example in which the tablet PC 10 is given a preset default orientation by the user, the inclination of this orientation is detected by the acceleration sensor 30, and video (mountain image) is displayed on the video display unit 17 in the correct direction.

In the examples of FIGS. 1A and 1B, the default orientation of the tablet PC 10 (landscape orientation) is such that a logo mark “ABC Corp.” stands correctly. In the example of FIG. 1A, the video (mountain image) is displayed on the video display unit 17 so as to be suitable for the default orientation of the tablet PC 10.

As shown in FIG. 1A, when a multichannel flag is detected, the speaker (first speaker 18A) that is located on the top-left of the video (mountain image) displayed on the video display unit 17 as viewed from the user outputs a surround L sound (SL sound), the speaker (second speaker 18B) located on the bottom-left of the video outputs an ordinary L sound (L sound), the speaker (third speaker 18C) located on the top-right of the video outputs a surround R sound (SR sound), and the speaker (fourth speaker 18D) located on the bottom-right of the video outputs an ordinary R sound (R sound). The term “ordinary sound” means a non-surround sound. The terms “stereo L sound” and “stereo R sound” mean the left (L) sound and the right (R) sound of a stereo sound, respectively.

FIG. 1B shows an example in which the tablet PC 10 has been rotated by 90° clockwise from the default orientation by the user, the inclination of the new orientation (portrait orientation) is detected by the acceleration sensor 30, and the video (mountain image) is displayed on the video display unit 17 so as to be suitable for the new orientation of the tablet PC 10.

As shown in FIG. 1B, when a multichannel flag is detected, the speaker (second speaker 18B) that is located on the top-left of the video (mountain image) displayed on the video display unit 17 as viewed from the user outputs a surround L sound (SL sound), the speaker (fourth speaker 18D) located on the bottom-left of the video outputs an ordinary L sound (L sound), the speaker (first speaker 18A) located on the top-right of the video outputs a surround R sound (SR sound), and the speaker (third speaker 18C) located on the bottom-right of the video outputs an ordinary R sound (R sound).

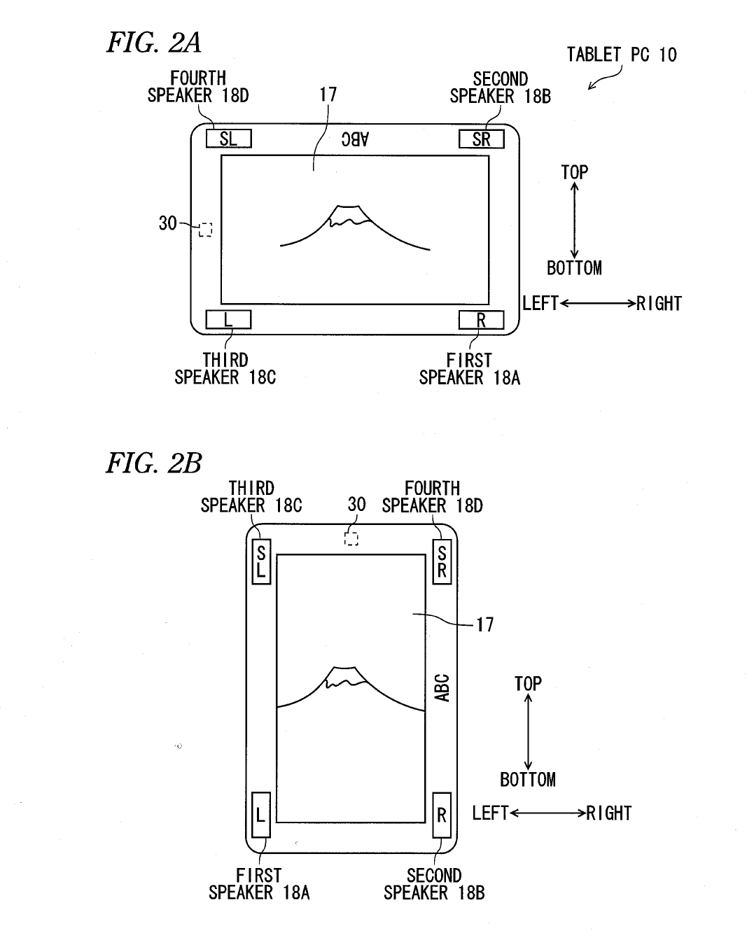

FIG. 2A shows an example in which the tablet PC 10 has been rotated by 90° clockwise from the orientation of FIG. 1B by the user, the inclination of the new orientation (landscape orientation) is detected by the acceleration sensor 30, and the video (mountain image) is displayed on the video display unit 17 so as to be suitable for the new orientation of the tablet PC 10.

As shown in FIG. 2A, when a multichannel flag is detected, the speaker (fourth speaker 18D) that is located on the top-left of the video (mountain image) displayed on the video display unit 17 as viewed from the user outputs a surround L sound (SL sound), the speaker (third speaker 18C) located on the bottom-left of the video outputs an ordinary L sound (L sound), the speaker (second speaker 18B) located on the top-right of the video outputs a surround R sound (SR sound), and the speaker (first speaker 18A) located on the bottom-right of the video outputs an ordinary R sound (R sound).

FIG. 2B shows an example in which the tablet PC 10 has been rotated by 90° clockwise from the orientation of FIG. 2A by the user, the inclination of the new orientation (portrait orientation) is detected by the acceleration sensor 30, and the video (mountain image) is displayed on the video display unit 17 so as to be suitable for the new orientation of the tablet PC 10.

As shown in FIG. 2B, when a multichannel flag is detected, the speaker (third speaker 18C) that is located on the top-left of the video (mountain image) displayed on the video display unit 17 as viewed from the user outputs a surround L sound (SL sound), the speaker (first speaker 18A) located on the bottom-left of the video outputs an ordinary L sound (L sound), the speaker (fourth speaker 18D) located on the top-right of the video outputs a surround R sound (SR sound), and the speaker (second speaker 18B) located on the bottom-right of the video outputs an ordinary R sound (R sound).

As described above, in the embodiment, when a multichannel flag is detected from a video content to be reproduced, the operation mode of the four speakers 18A-18D is changed to a multichannel mode (e.g., from a 2-channel mode to a 4-channel mode).

In the case of a 5 ch signal, an effective method for dealing with it with the four speakers 18A-18D is to configure the tablet PC 10 so that the top-left and top-right speakers can reproduce respective surround signals LS and RS and the bottom-left and bottom-right speakers can reproduce respective signals that are added with a center-channel signal. With this measure, the two speakers located above the video display unit 17 can reproduce a surround sound effectively while the two speakers located below the video display unit 17 realizes center localization.

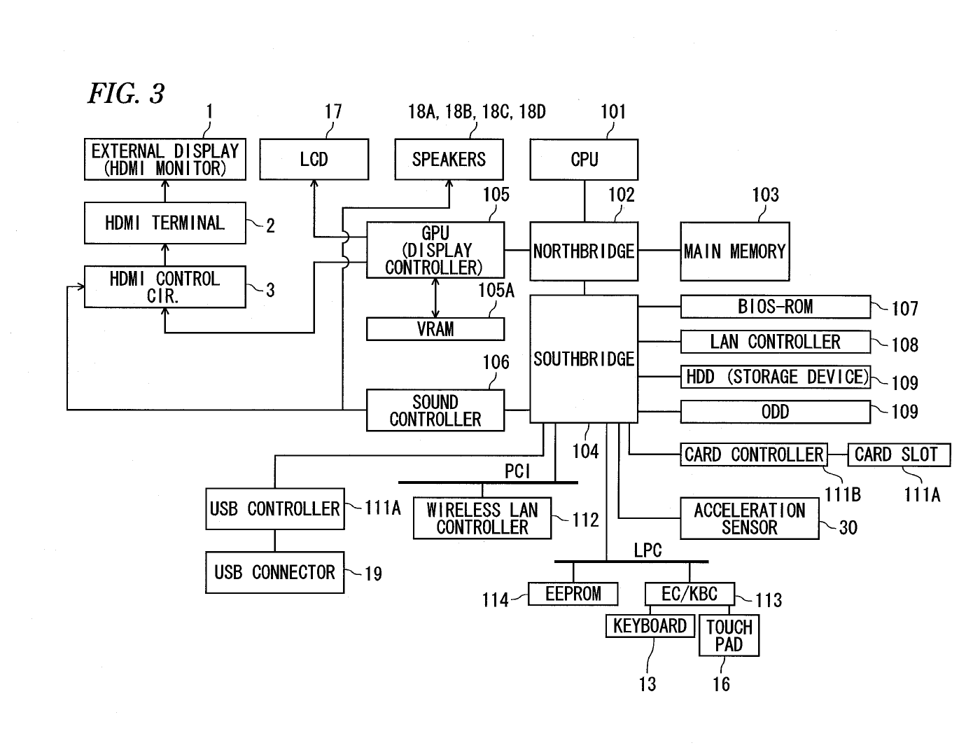

FIG. 3 is a block diagram showing an example configuration of the tablet PC 10 according to the embodiment. At least part of the components (electronic components) shown in FIG. 3 are provided in the tablet (slate) PC 10.

The tablet PC 10 is equipped with a CPU (central processing unit) 101, a northbridge 102, a main memory 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD; storage device) 109, an optical disc drive (ODD) 110, a USB controller 111A, a card controller 111B, a wireless LAN controller 112, an embedded controller/keyboard controller (EC/KBC) 113, an EEPROM (electrically erasable programmable ROM) 114, etc.

The CPU 101 is a processor which controls operations of individual components of the tablet PC 10. The CPU 101 runs a BIOS which is stored in the BIOS-ROM 107. The BIOS is programs for hardware control.

The northbridge 102 is a bridge device which connects a local bus of the CPU 101 to the southbridge 104. The northbridge 102 incorporates a memory controller for access-controlling the main memory 103. The northbridge 102 also has a function of performing a communication with the GPU 105 via, for example, a serial bus that complies with the PCI Express standard.

The GPU 105 is a display controller which controls the video display unit (LCD) 17 which is used as a display monitor of the tablet PC 10. A display signal generated by the GPU 105 is sent to the video display unit (LCD) 17. The GPU 105 can also send a digital video signal to an external display 1 via an HDMI control circuit 3 and an HDMI terminal 2.

The HDMI terminal 2 is an external display connection terminal. The HDMI terminal 2 can send a non-compressed digital video signal and digital audio signal to the external display 1 such as a TV receiver via a single cable. The HDMI control circuit 3 is an interface for sending a digital video signal to the external display 1 (called an HDMI monitor) via the HDMI terminal 2.

The southbridge 104 controls individual devices on a PCI (peripheral component interconnect) bus and individual devices on an LPC (low pin count) bus. The southbridge 104 incorporates an IDE (integrated drive electronics) controller for controlling the HDD 109 and the ODD 110. The southbridge 104 also has a function of performing a communication with the sound controller 106.

The sound controller 106, which is a sound source device, outputs reproduction subject audio data to at least four speakers 18A-18D or the HDMI control circuit 3. The LAN controller 108 is a wired communication device which performs a wired communication according to the IEEE 802.3 standard, for example. On the other hand, the wireless LAN controller 112 is a wireless communication device which performs a wireless communication according to the IEEE 802.11g standard, for example.

The USB controller 111A performs a communication with an external device (connected to it via a USB connector 19) which complies with the USB 2.0 standard, for example. For example, the USB controller 111A is used for receiving an image data file from a digital camera. The card controller 111B writes and reads data to and from a memory card such as an SD card that is inserted in a card slot 111C that is formed in a computer main body of the tablet PC 10.

The EC/KBC 113 is a one-chip microcomputer in which an embedded controller for power management and a keyboard controller for controlling a keyboard 13 and a touch pad 16 are integrated together. The EC/KBC 113 has a function of powering on/off the tablet PC 10 in response to a user manipulation of a power button.

In the embodiment, a display control is performed in such a manner that, for example, the CPU 101 runs programs stored in the main memory 103, the HDD 109, etc.

In the embodiment, the above-described acceleration sensor 30 is housed in the cabinet of the tablet PC 10.

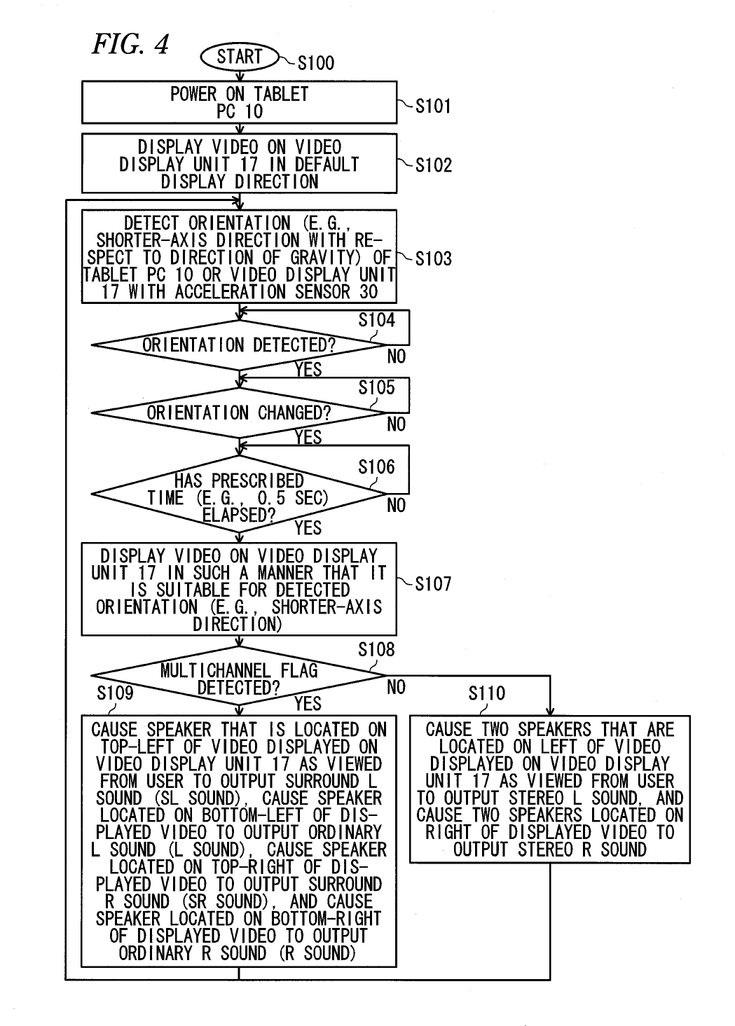

FIG. 4 is a flowchart of a process which is executed by the tablet PC 10 according to the embodiment. The process starts at step S100.

At step S101, the tablet PC 10 is powered on. At step S102, video is displayed on the video display unit 17 in the default display direction (described above).

At step S103, an orientation of the tablet PC 10 or the video display unit 17 is detected by the acceleration sensor 30. For example, the acceleration sensor 30 detects, for example, the shorter-axis direction with respect to the direction of gravity.

At step S104, it is judged whether an orientation of the tablet PC 10 or the video display unit 17 has been detected. If it is judged that an orientation of the tablet PC 10 or the video display unit 17 has been detected (S104: yes), the process moves to step S105. If not (S104: no), step S104 is executed again.

At step S105, it is judged whether the orientation of the tablet PC 10 or the video display unit 17 detected by the acceleration sensor 30 has been changed or not. If it is judged that the orientation of the tablet PC 10 or the video display unit 17 has been changed (S105: yes), the process moves to step S106. If not (S105: no), step S105 is executed again.

At step S106, it is judged whether or not a prescribed time (e.g., 0.5 sec) has elapsed with the new orientation of the tablet PC 10 or the video display unit 17 kept as it is. If it is judged that the prescribed time has elapsed with the new orientation of the tablet PC 10 or the video display unit 17 kept as it is (S106: yes), the process moves to step S107. If not (S106: no), step S106 is executed again.

At step S107, the video is displayed on the video display unit 17 in such a manner that it is suitable for the detected orientation (e.g., the shorter-axis direction).

At step S108, processing of detecting a multichannel flag from an audio signal corresponding to the displayed video is performed and it is judged whether a multichannel flag has been detected or not. If it is judged that a multichannel flag has been detected (S108: yes), the process moves to step S109. If not (S108: no), the process moves to step S110.

At step S109, as shown in FIGS. 1A and 1B and FIGS. 2A and 2B, the speaker that is located on the top-left of the video displayed on the video display unit 17 as viewed from the user is caused to output a surround L sound (SL sound), the speaker located on the bottom-left of the video is caused to output an ordinary L sound (L sound), the speaker located on the top-right of the video is caused to output a surround R sound (SR sound), and the speaker located on the bottom-right of the video is caused to output an ordinary R sound (R sound). Then, the process returns to step S103.

At step S110, although not shown in any drawings, if no multichannel flag is detected, a sound control section causes the two speakers that are located on the left of the displayed video as viewed from the user to output a stereo L sound and causes the two speakers located on the right of the video to output a stereo R sound. Then, the process returns to step S103.

As described above, in the tablet PC 10 according to the embodiment, as shown in FIGS. 1A and 1B and FIGS. 2A and 2B, if a multichannel flag is detected from a movie content, a musical program, a variety program, or the like, the speaker that is located on the top-left of video (e.g., mountain image) displayed on the video display unit 17 as viewed from the user outputs a surround L sound (SL sound), the speaker located on the bottom-left of the video outputs an ordinary L sound (L sound), the speaker located on the top-right of the video outputs a surround R sound (SR sound), and the speaker located on the bottom-right of the video outputs an ordinary R sound (R sound).

That is, the tablet PC 10 according to the embodiment is a portable apparatus which can be used being held by a hand(s), the user can enjoy a surround sound even if he or she rotates it about the axis that is perpendicular to the screen. Furthermore, enabling multichannel reproduction, the tablet PC 10 allows the user to enjoy a feeling of surround sound depending on the content.

As described above, an electronic apparatus (tablet PC 10) according to the embodiment is provided with a detection unit for detecting an orientation of the self apparatus; a video display unit for displaying video in such a manner that it is suitable for the detected orientation; four speakers disposed in the vicinities of four respective corners of the video display unit; a flag detecting section for detecting a multichannel flag corresponding to the video; and a sound control section for causing a speaker that is located on the top-left of the displayed video as viewed from a user to output a surround L sound (SL sound), causes a speaker located on the bottom-left of the displayed video to output an ordinary L sound (L sound), causes a speaker located on the top-right of the displayed video to output a surround R sound (SR sound), and causes a speaker located on the bottom-right of the displayed video to output an ordinary R sound (R sound), if the flag detecting section detects a multi-channel flag.

If the flag detecting section does not detect a multi-channel flag, the sound control section causes two speakers that are located on the left of the displayed video as viewed from the user to output a stereo L sound and causes two speakers located on the right of the displayed video to output a stereo R sound.

The detection unit may detect an orientation of the self apparatus by utilizing gravity.

The detection unit detects an orientation of the self apparatus using an acceleration sensor 30.

The video display unit displays video in such a manner that it is suitable for the detected orientation when the detected orientation has been maintained for a prescribed time.

The detection unit detects an orientation of one of the self apparatus and the video display unit.

With the above measures, the electronic apparatus according to the embodiment can reduce the degree of an uncomfortable feeling that the user experiences about an output sound when the video display direction is changed.

All the steps of the control process according to the embodiment can be implemented by software. Therefore, the advantages of the embodiment can easily be obtained merely by installing a program of the control process in an ordinary computer via a computer-readable storage medium that is stored with the program and running the installed program.

The invention is not limited to the above embodiment itself and, in the practice stage, may be embodied in such a manner that constituent elements are modified in various manners without departing from the spirit and scope of the invention. And various inventive concepts may be conceived by properly combining plural constituent elements disclosed in the embodiment. For example, several ones of the constituent elements of the embodiment may be omitted.

What is claimed is:

1. An electronic apparatus comprising:
a first detector configured to detect an orientation of the electronic apparatus;
a video display unit configured to display video so that the video is oriented based on the detected orientation;
a second detector configured to detect whether an audio signal of the video is corresponding to multichannel reproduction; and
a sound controller configured to cause a first speaker that is located on a top-left of the displayed video as viewed from a position in front of the video display unit to output a surround L sound, cause a second speaker located on a bottom-left of the displayed video to output an ordinary L sound, cause a third speaker located on a top-right of the displayed video to output a surround R sound, and cause a fourth speaker located on a bottom-right of the displayed video to output an ordinary R sound, in a case that the second detector detects that the audio signal is corresponding to the multi-channel reproduction.

2. The electronic apparatus of claim 1, wherein
in a case that the second detector detects that the audio signal is not corresponding to the multi-channel reproduction, the sound controller causes the first and second speakers that are located on a left of the displayed video as viewed from the position in front of the video display unit to output a stereo L sound and causes the third and fourth speakers located on a right of the displayed video to output a stereo R sound.

3. The electronic apparatus of claim 1, wherein
the first detector detects the orientation of the electronic apparatus using a sensor which utilizes gravity.

4. The electronic apparatus of claim 1, wherein
the first detector detects the orientation of the electronic apparatus using an acceleration sensor.

5. The electronic apparatus of claim 1, wherein
the video display unit displays video in such a manner that it is oriented in a direction based on the detected orientation when the detected orientation has been maintained for a prescribed time.

6. The electronic apparatus of claim 1, wherein
the first detector detects the orientation of one of the electronic apparatus and the video display unit.

7. A control method of an electronic apparatus, comprising:
detecting an orientation of the electronic apparatus;
displaying video in such a manner that it is oriented in a direction based on the detected orientation;
detecting whether an audio signal of the video is corresponding to multichannel reproduction; and
causing a first speaker that is located on a top-left of the displayed video as viewed from a position in front of the video display unit among four speakers, each one of the four speakers in each of four corners of a video display unit, to output a surround L sound, causing a second speaker located on a bottom-left of the displayed video to output an ordinary L sound, causing a third speaker located on a top-right of the displayed video to output a surround R sound, and causing a fourth speaker located on a bottom-right of the displayed video to output an ordinary R sound, in a case that the audio signal is corresponding to the multichannel reproduction.

8. A non-transitory recording medium configured to store a control program for controlling an electronic apparatus, the control program causing the electronic apparatus to execute the steps of:
detecting an orientation of the electronic apparatus;
displaying video in such a manner that it is oriented in a direction based on the detected orientation;
detecting whether an audio signal of the video is corresponding to multichannel reproduction;
causing a first speaker that is located on a top-left of the displayed video as viewed from a position in front of a video display unit, among four speakers, each of the four speakers in each of four corners of the video display unit to output a surround L sound, causing a second speaker located on a bottom-left of the displayed video to output an ordinary L sound, causing a third speaker located on a top-right of the displayed video to output a surround R sound, and causing a fourth speaker located on a bottom-right of the displayed video to output an ordinary R sound, in a case that the audio signal is corresponding to the multichannel reproduction.
